(19) United States
(12) Patent Application Publication
(10) Pub. No.: US 2021/0009816 A1
(43) Pub. Date: Jan. 14, 2021

(54) WATER RESISTANT VOIDED POLYMER PARTICLES

(71) Applicant: Arkema Inc., King of Prussia, PA (US)

(72) Inventors: Lily Liu, Oak Ridge, TN (US); Keith J. Andes, Apex, NC (US); Wayne Devonport, Apex, NC (US); Matthew F. Boudreaux, Raleigh, NC (US)

(21) Appl. No.: 16/969,581

(22) PCT Filed: Feb. 19, 2019
(86) PCT No.: PCT/US2019/018456

§ 371 Date: Aug. 13, 2020

Related U.S. Application Data
(60) Provisional application No. 62/633,629, filed on Feb. 22, 2018.

(51) Int. Cl. C09D 5/02; B01J 13/14; B01J 13/22; C09D 133/12; C09D 133/02; C09D 7/40

(52) U.S. Cl. CPC C09D 5/022; B01J 13/14; C09D 7/70; C09D 133/12; C09D 133/02; B01J 13/22

(57) ABSTRACT

Latex emulsions and a process of making the same that incorporates voided latex particles having a core with a hydrophilic component; at least one intermediate shell with, as polymerized units, one or more hydrophilic monoethylenically unsaturated monomer, one or more nonionic monoethylenically unsaturated monomer, or mixtures thereof; an outer shell formed of a polymer having a Tg of at least 60? C; and a surface treatment applied to the outer shell in which a plurality of silicone oligomers with reactive functional groups are cross-linked with one another in order to provide a cross-linked outer surface. The core and the at least one intermediate shell are contacted with a swelling agent in the presence of less than 0.5% monomer based on the overall weight of the voided latex particles. In addition, one or more of the core, the intermediate shell, or the outer shell includes a surfactant.

### FIELD

This disclosure relates generally to hollow polymer particles, a process for producing said hollow particles, and coating compositions that incorporate the same. More specifically, the present disclosure is related to polymer particles that have an internal void structure and a functionalized, cross-linked surface.

### BACKGROUND

The statements in this section merely provide background information related to the present disclosure and may not constitute prior art.

Paints and coatings play an important role in preserving, protecting and beautifying the objects to which they are applied. For example, architectural paints are used to decorate and extend the service life of the interior and exterior surfaces in both residential and commercial buildings.

Hollow glass and ceramic microspheres, as well as fillers, such as calcined clay, titanium dioxide (TiO₂), zinc oxide (ZnO), talc, calcium carbonate (CaCO₃), and silica aerogels are commercially available for use as opacifying additives in paints and coatings. However, since inorganic hollow microspheres are large having an overall diameter that is on the order of a few micrometers, their use is inherently limited. Inorganic hollow spheres also lack the synthetic capacity for low polydispersity and have a thin shell that is extremely sensitive and prone to damage.

Hollow polymer particles have also been developed for use in paints and other coatings as non-film forming opacifying additives. As such, these hollow polymer particles are typically used as full or partial replacements for other opacifying additives. However, known processes for preparing these hollow polymer particles typically include a separate swelling step that occurs after polymerization of the core and shell layers or in between formation of shell layers. This type of process often produces a shell thickness, void diameter, particle size, and/or particle morphology (e.g., the formation of penetrating pores) that affects overall performance of the finished product. For example, although conventional hollow polymer particles can provide opacity, they may also exhibit an undesirable balance of other properties, such as gloss, strength, water resistance, and weatherability.

### SUMMARY

The present disclosure generally provides hollow or voided latex particles. These voided latex particles comprise, consist of, or consist essentially of a core comprising a hydrophilic component; at least one intermediate shell comprising, as polymerized units, one or more hydrophilic monoethylenically unsaturated monomer, one or more nonionic monoethylenically unsaturated monomer, or mixtures thereof; an outer shell comprising a polymer having a T_{g} of at least 60° C.; and a surface treatment applied to the outer shell comprising a plurality of silicone monomers, oligomers, and/or polymers having polymerizable or cross-linkable functional groups, the functional groups being cross-linked with one another in order to provide a cross-linked outer surface. The core and the at least one intermediate shell are contacted with a swelling agent in the presence of less than 0.5% monomer based on the overall weight of the voided latex particles. In addition, one or more of the core, the intermediate shell, or the outer shell includes sodium dodecylbenzene sulfonate, and optionally other surfactants.

The voided latex particles may further comprise a polymerization initiator selected as one from a free radical initiator and a redox polymerization initiator. At least one of the intermediate layers may comprise a cross-linked polymer. When desirable, the voided latex particles may comprise a first intermediate layer that include a copolymer of methacrylic acid, styrene, and methyl methacrylate and a second intermediate layer comprising copolymerized methyl methacrylate and styrene.

The core may comprise a polymer seed that includes methyl methacrylate and a seed coating of copolymerized methacrylic acid and methyl methacrylate. The swelling agent for the core is typically a base, such as sodium hydroxide or ammonia hydroxide. The core and the at least one intermediate shell are contacted with a swelling agent in the presence of less than 0.5% monomer based on the overall weight of the voided latex particles,

The outer shell is polymerized styrene or styrene copolymerized with one or more functionalized monomers. When desirable, the surface treatment may comprise γ-metha-cryloxypropyltrimethoxysilane or trimethyl-methyl silyl methacrylate. The surface treatment may undergo, without limitation, redox polymerization or thermal persulfate polymerization

According to another aspect of the present disclosure a latex emulsion is formed. This latex emulsion generally comprises 5 wt. % to about 60 wt. % hollow or voided latex particles based on the overall weight of the latex emulsion; about 40 wt. % to 95 wt. % of an aqueous medium in which the voided latex particles are dispersed; and optionally, one or more other polymers, pigments, or additives. The voided latex particles include the composition as described above and that is further defined herein.

According to yet another aspect of the present disclosure, a process for forming hollow or voided latex particles is provided. This process generally comprises: forming a particle comprising a core and at least one intermediate shell; contacting the particle with a swelling agent; polymerizing an outer shell at least partially encapsulating the particle; allowing the particle to swell, thereby, forming a swollen particle; applying a surface treatment to the outer shell having polymerizable or cross-linkable functional groups; and allowing the functional groups to crosslink. The voided latex particles formed by this process have the composition described above and further defined herein. The core and the at least one intermediate shell are contacted with swelling agent in the presence of less than 0.5% monomer based on the weight of the multi-stage emulsion polymer particles. In addition, one or more of the core, the intermediate shell, or the outer shell includes sodium dodecylbenzene sulfonate, and optionally other surfactants and substantially all of the swelling occurs during polymerization of the outer shell.

When desirable, the process may further comprise adding a sufficient amount of a polymerization initiator prior to said contacting with swelling agent to reduce the amount of monomer present during the contacting with swelling agent to less than 0.5% monomer based on the weight of the voided latex particles.

According to another aspect of the present disclosure the at least one intermediate shell of the voided latex particles comprises a cross linked polymer, the swelling agent is sodium hydroxide, the core comprises a polymer seed comprising methyl methacrylate and a seed coating of copolymerized methacrylic acid and methyl methacrylate, the outer shell is polymerized styrene or styrene copolymerized with one or more functionalized monomers, and the surface treatment comprises γ-methacryloxypropyltrimethoxysilane or trimethyl-methyl silyl methacrylate.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a scanning electron micrograph (SEM) of the voided latex particles of the present disclosure;

FIG. 2 is a scanning transmission electron micrograph (STEM) of the voided latex particles of the present disclosure analyzed for carbon atoms;

FIG. 3 is a scanning transmission electron micrograph (STEM) of the voided latex particles of the present disclosure analyzed for silicon atoms; and

FIG. 4 is a schematic representation of a process for forming the voided latex particles according to the teachings of the present disclosure.

The drawings described herein are for illustration purposes only and are not intended to limit the scope of the present disclosure in any way. It should be understood that throughout the drawings, corresponding reference numerals indicate like or corresponding parts and features.

### DETAILED DESCRIPTION

The following description is merely exemplary in nature and is not intended to limit the present disclosure, application, or uses. For example, the voided latex particles made and used according to the teachings contained herein is described throughout the present disclosure in conjunction with opacifying additives used in paints and coatings in order to more fully illustrate the composition and the use thereof. The incorporation of these voided latex particles as opacifying additives in other product compositions that are used in other applications or products are contemplated to be within the scope of the present disclosure. Such product compositions may include, but not be limited to polymer composites, adhesives, sealants, caulks, inks, or the like.

The present disclosure generally provides polymer particles that are silane-functionalized and have an internal voided structure. The voided latex particles of the invention are water resistant, and can provide the same or similar performance, such as hiding power or providing opacity for example, both in a dry state and a wet state. For example, in both the dry state and when dispersed in an aqueous environment (i.e., wet state and/or in the presence of water) the voided latex particles of the invention impart a similar color, e.g., white, whereas voided latex particles that are not of the invention turn transparent eventually. Similar behavior in both dry and wet states is desirable for many applications, such as for wet opaque labels or underwater applications, including adhesives and labels.

Without intending to be bound to any theory, for voided latex particles, absorbing and releasing water from the internal voids generally is an equilibrium process. By making the polymer shell less water permeable, the water-resistancy of the voided particles may be enhanced.

For the purpose of this disclosure, the voided latex particles prepared by the process of the present invention may be characterized as being “non-film-forming.” By “non-film-forming” it is meant that the voided latex particles will not form a film at ambient temperature or below, or in other words will only form a film at temperatures above ambient temperature. For the purposes of this specification, ambient temperature is taken as being in the range of 15° C. to 45° C.; alternatively, between 20° C. and 30° C. Thus, for example, when incorporated into an aqueous coating composition, applied to a substrate temperature and dried or cured at ambient temperature or below, the voided latex particles do not form a film. The voided latex particles generally remain as discrete particles in the dried or cured coating. The voided latex particles are capable of functioning as opacifiers; that is, when added in sufficient amount to a coating composition that would otherwise be transparent when dried, they render the dried coating composition opaque. By the term “opaque”, it is meant that the refractive index of a coating composition has a higher refractive index when the voided latex particles of the present disclosure are present in a coating composition as compared to the same coating composition not including the voided latex particles of the present disclosure wherein the refractive index is measured after the coatings are dry to the touch. The term “outer shell polymer” refers to the outer layer of the voided particles of the present disclosure after swelling.

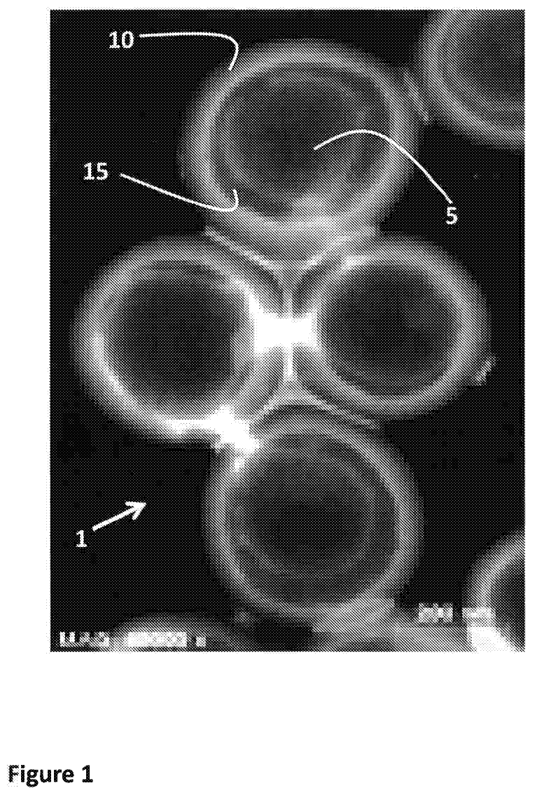

Referring to FIG. 1, the voided latex particles 1 according to one aspect of the present disclosure comprise, consist of, or consist essentially of a hollow interior or core 5 and an outer shell 10 which encloses the core, although as will be explained subsequently in more detail one or more additional intermediate layers 15 may also be present between the outer shell 10 and the core 5 of each particle 1. The voided latex particles 1 generally have a diameter that is at least 200 nm; alternatively at least 300 nm; alternatively, less than 1200 nm; alternatively, not more than 900 nm; alternatively, about 600 nm or less; alternatively, between about 250 nm and about 550 nm; or alternatively, between about 350 nm and about 450 nm. The core 5 generally has a diameter that is at least 100 nm; alternatively, at least 150 nm and typically less than 1000 nm; alternatively, not more than 700 nm; alternatively, 400 nm or less. The thickness of the layers surrounding the core 5, including the outer shell 10 and also any additional intermediate layers 15 which may be present, generally range from about 30 to about 150 nm; alternatively, between about 75 nm and about 125 nm; alternatively, about 100 nm.

The voided latex particles 1 are approximately spherical in shape, although oblong, oval, teardrop, or other shapes are also possible without exceeding the scope of the present disclosure. Particles with penetrating pores are undesirable and are not produced in any substantial quantity (e.g., less than 0.5% of particles on average). Particle dimensions and morphology may be determined upon examining the particles using high resolution electron microscopic techniques, such as scanning electron microscopy (SEM) or scanning transmission electron microscopy (STEM). The percentage of particles with penetrating pores, i.e., those with large pores visible in SEM or STEM images connecting the hollow core to the outer surface of the voided latex particles, are determined by counting particles with penetrating pores (if any) as visualized in the SEM or STEM images as a percentage of the total particle count in a representative sample.

The core component 5 of the voided latex particles 1 is generally located at or near the center of the particles. However, when desirable, the core 5 may coat and surround a seed which is comprised of a polymer different from the polymer used to prepare the core. In this case, for example, the seed may comprise a polymer which is non-hydrophilic in character; i.e., the seed polymer may be a homopolymer or copolymer of one or more non-ionic monoethylenically unsaturated monomers such as methyl methacrylate. Alternatively, the seed polymer is a methyl methacrylate homopolymer which is resistant to swelling by the swelling agent used to swell the core. The seed typically will have a particle size of from about 30 to about 200 nm; alternatively, from about 50 to about 100 nm. In order to form the core, the seed is coated with another polymer which is comprised of at least one hydrophilic monoethylenically unsaturated monomer, optionally in combination with at least one non-hydrophilic monoethylenically unsaturated monomer such as an alkyl (meth)acrylate and/or a vinyl aromatic monomer. Sufficient hydrophilic monoethylenically unsaturated monomer should be used, however, such that the resulting polymer is capable of being swollen with a swelling agent, including without limitation, an aqueous base. In one non-limiting example, the polymer used to coat the seed and provide the core component may be a copolymer of methyl methacrylate and methacrylic acid, the methacrylic acid content of the copolymer being about 30 to about 60 weight percent.

The core 5 of the voided latex particles 1 comprises a hydrophilic component that provides a sufficient degree of swelling that allows for the formation of a void or a hollow space. The hydrophilic component may be provided in the form of a hydrophilic monomer used to prepare the core polymer. In other words, the polymer used to obtain the core includes polymerized units of a hydrophilic monomer, in an amount effective to render the core polymer hydrophilic. Alternatively, the hydrophilic component may be an additive to the core, which generally means that the hydrophilic component is admixed with a non-hydrophilic polymer prior to or during the formation of the core. When desirable, the hydrophilic component may be present both as an additive embedded in the core and as a hydrophilic polymer which is part of the core. The hydrophilic component may be, without limitation, an acid-containing monomer or additive, such as a monomer or additive bearing carboxylic acid functional groups.

The core 5 may also be formed without exceeding the scope of the present disclosure by converting one or more of the polymers used to prepare the core to a swellable component after the polymer has already been prepared. For example, a polymer containing vinyl acetate units can be hydrolyzed to form a core polymer having a sufficient number of hydroxyl groups, which renders the polymer capable of being swelled.

The hydrophilic component of the core 5 may be provided by polymerization or copolymerization of one or more monoethylenically unsaturated monomers bearing an ionizable functional group, such as acid functionality. When desirable, the hydrophilic monoethylenically unsaturated monomer can be co-polymerized with at least one nonionic monoethylenically unsaturated monomer. The hydrophilic monoethylenically unsaturated monomer may be present in the core polymer in amounts of, as polymerized units, ranging from about 5 to about 80; alternatively, from about 15 to about 75; alternatively, from about 30 to about 60; alternatively, from about 40 to about 50, percent by weight, based on the weight of core polymer. Several examples of hydrophilic monoethylenically unsaturated monomers, include but are not limited to monomers that contain at least one carboxylic acid group, such as acrylic acid, methacrylic acid, acryloxypropionic acid, (meth)acryloxypropionic acid, itaconic acid, aconitic acid, maleic acid or anhydride, fumaric acid, crotonic acid, monomethyl maleate, monomethyl fumarate, monomethyl itaconate, and the like. Alternatively, the hydrophilic monoethylenically unsaturated monomer may be acrylic acid or methacrylic acid.

Hydrophilic non-polymeric components, which also be present in the core 5 include, without limitation, compounds that contain one or more carboxylic acid groups, such as aliphatic or aromatic monocarboxylic acids and dicarboxylic acids. Several specific examples of aliphatic or aromatic monocarboxylic acids and dicarboxylic acids include but are not limited to benzoic acid, m-toluic acid, p-chlorobenzoic acid, o-acetoxybenzoic acid, azelaic acid, sebacic acid, octanoic acid, cyclohexanecarboxylic acid, lauric acid, monobutyl phthalate, and the like.

The core 5 polymer may additionally contain recurring units that are derived from non-ionic monomers. Examples of non-ionic monomers that may be present in polymerized form in the swellable core polymer include without limitation vinyl aromatic monomers or olefins. Several specific examples of vinyl aromatic monomers include but are not limited to styrene, a-methyl styrene, p-methyl styrene, t-butyl styrene, and vinyltoluene. Several specific examples of such olefins include but are not limited to ethylene, vinyl acetate, vinyl chloride, vinylidene chloride, (meth)acrylonitrile, (meth)acrylamide, (C₁-C₂₀) alkyl or (C₃-C₂₀) alkenyl esters of (meth)acrylic acid, such as methyl (meth)acrylate, ethyl (meth)acrylate, butyl (meth)acrylate, 2-ethylhexyl (meth)acrylate, hydroxyethyl(meth)acrylate, hydroxypropyl(meth)acrylate, benzyl (meth)acrylate, lauryl (meth)acrylate, oleyl (meth) acrylate, palmityl (meth)acrylate, stearyl (meth)acrylate and the like.

The core 5 polymer may further contain polyethylenically unsaturated monomer in amounts, as polymerized units, ranging from about 0.1 to about 20 weight percent. Examples of suitable polyethylenically unsaturated monomers include co-monomers that contain at least two polymerizable vinylidene groups, such as α,β-ethylenically unsaturated monocarboxylic acid esters of polyhydric alcohols containing 2-6 ester groups, as well as alkylene glycol diacrylates and dimethacrylates. Several specific examples of alkylene glycol diacrylates and dimethacrylates, include but are not limited to ethylene glycol diacrylate, ethylene glycol dimethacrylate, 1,3-butylene glycol diacrylate, 1,4-butylene glycol diacrylate propylene glycol diacrylate, and triethylene glycol dimethylacrylate, 1,3-glycerol dimethacrylate, 1,1,1-trimethylol propane dimethacrylate, 1,1,1-trimethylol ethane diacrylate, pentaerythritol trimethacrylate, 1,2,6-hexane triacrylate, sorbitol pentamethacrylate, methylene bis-acrylamide, methylene bis-methacrylamide, divinyl benzene, vinyl methacrylate, vinyl crotonate, vinyl acrylate, vinyl acetylene, trivinyl benzene, triallyl cyanurate, divinyl acetylene, divinyl ethane, divinyl sulfide, divinyl ether, divinyl sulfone, diallyl cyanamide, ethylene glycol divinyl ether, diallyl phthalate, divinyl dimethyl silane, glycerol trivinyl ether, divinyl adipate, dicyclopentenyl (meth)acrylates, dicyclopentenyloxy (meth)acrylates, unsaturated esters of glycol monodicyclopentenyl ethers, allyl esters of α,β-unsaturated mono- and dicarboxylic acids having terminal ethylenic unsaturation including allyl methacrylate, allyl acrylate, diallyl maleate, diallyl fumarate, diallyl itaconate and the like.

Referring once again to FIG. 1, the voided latex particles 1 may contain one or more intermediate layers 15. The intermediate layer 15 may be comprised of one or more polymers that partially or fully encapsulate the core 5. Each intermediate layer 15 may be partially or fully encapsulated by another intermediate layer 15. Each individual intermediate layer 15 may be prepared by emulsion polymerization conducted in the presence of the core 5 or a core 5 encapsulated by one or more preceding intermediate layers 15. The intermediate layer 15 may function as a compatiblizing layer, sometimes referred to as a tie or tie coat layer, between other layers of voided latex particles 1 formed by a multi-stage emulsion polymer process. In other words, the intermediate layer 15 may assist in adhering the outer shell 10 to the core 5. An intermediate layer 15 may also serve to modify predetermined properties or other characteristics of the final voided latex particles 1.

According to another aspect of the present disclosure, one or more intermediate layers 15 may comprise an encapsulating polymer containing, as polymerized units, one or more hydrophilic monoethylenically unsaturated monomers and one or more nonionic monoethylenic ally unsaturated monomers. The hydrophilic monoethylenically unsaturated monomers and the nonionic monoethylenically unsaturated monomers useful for making the core 5 as previously described above are also useful for making such intermediate layers 15. However, in general, the intermediate the encapsulating polymer of the intermediate layer 15 contains a lower proportion of hydrophilic monomer than the polymer of the core 5. Thus the encapsulating polymer of the intermediate layer 15 will swell less than the core 5 when contact is made with the swelling agent. When desirable, the intermediate layer 15 may contain, as polymerized units, non-ionic monoethylenically unsaturated monomer and little or no (e.g., less than 5 weight %) hydrophilic monoethylenically unsaturated monomer. The intermediate layer may further include crosslinking agents such as alkylene glycol diacrylates and dimethacrylates, such as for example, ethylene glycol diacrylate, ethylene glycol dimethacrylate, 1,3-butylene glycol diacrylate, 1,4-butylene glycol diacrylate propylene glycol diacrylate and triethylene glycol dimethylacrylate, 1,3-glycerol dimethacrylate, 1,1,1-trimethylol propane dimethacrylate, 1,1,1-trimethylol ethane diacrylate, pentaerythritol trimethacrylate, 1,2,6-hexane triacrylate, sorbitol pentamethacrylate, methylene bis-acrylamide, methylene bis-methacrylamide, divinyl benzene, vinyl methacrylate, vinyl crotonate, vinyl acrylate, vinyl acetylene, trivinyl benzene, triallyl cyanurate, divinyl acetylene, divinyl ethane, divinyl sulfide, divinyl ether, divinyl sulfone, diallyl cyanamide, ethylene glycol divinyl ether, diallyl phthalate, divinyl dimethyl silane, glycerol trivinyl ether, divinyl adipate, dicyclopentenyl (meth)acrylates, dicyclopentenyloxy(meth)acrylates, unsaturated esters of glycol monodicyclopentenyl ethers, and allyl esters of α,β-unsaturated mono- or dicarboxylic acids having terminal ethylenic unsaturation including allyl methacrylate, allyl acrylate, diallyl maleate, diallyl fumarate, diallyl itaconate and the like.

Still referring to FIG. 1, the outer shell 10 is polymeric and may, for example, be comprised of a thermoplastic polymer. The polymer of the outer shell 10 has a glass transition temperature (T_{g}) that is above ambient temperature; alternatively, at or above 60° C.; alternatively, at least 80° C. Alternatively, the T_{g} of the outer shell's polymer may range from 60° C. to about 140° C. The glass transition temperature (T_{g}) may be determined using differential scanning calorimetry (DSC), or any other known technique.

The polymer of the outer shell 10 may be a homopolymer or a copolymer comprised of recurring polymerized units of two or more different monomers. Several examples of such monomers include, without limitation, ethylenically unsaturated monomers as previously described above and further defined herein that are capable of being polymerized by free radical polymerization.

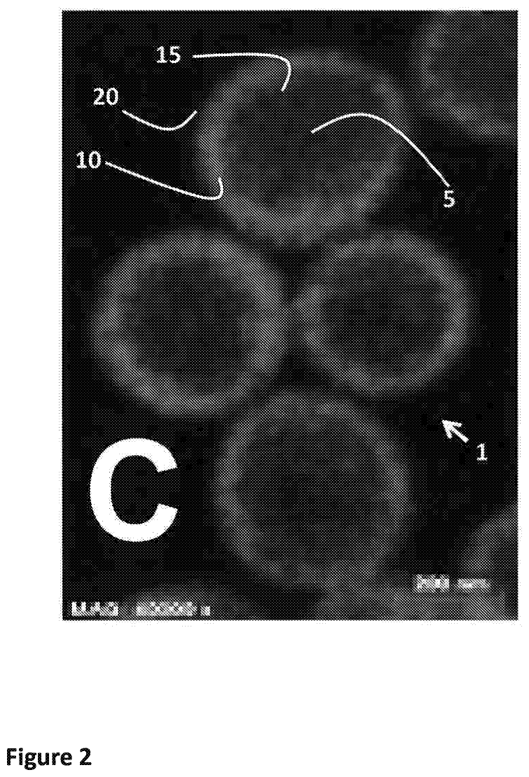

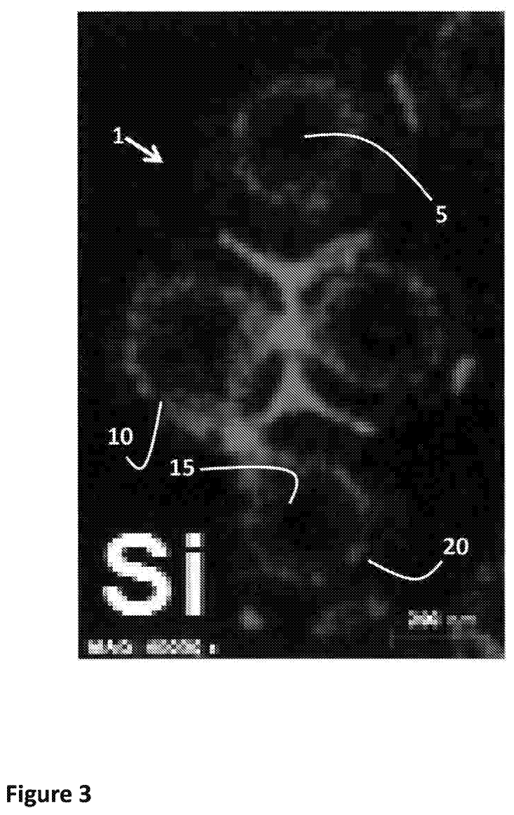

Referring now to FIGS. 2 and 3, the outer shell 10 of the voided latex particles 1 is further characterized by an outer surface 20 that is substantially cross-linked. The cross-linked outer surface is formed by the cross-linking of functional groups attached to a plurality of silicone oligomers that are either bonded, attracted, or embedded into the outer shell 15 layer of the voided latex particles 1. Similar to silane coupling agents, these silicone oligomers generally comprise a silicon atom coupled to at least one organic moiety and one or more hydrolyzable groups. Alternatively, the ratio of organic moieties per silicon atom is on the order of 1:1 to 3:1; alternatively, 1:1 or 2:1; alternatively, 1:1. The ratio of hydrolysable groups per silicon atom may range from 3:1 to 1:1; alternatively, 2:1 to 1:1; alternatively, 3:1.

The organic moiety may generally comprise a molecular aliphatic chain that includes a plurality of —CH₂— groups coupled to a silicon atom and to a reactive organofunctional end group. The number of carbon atoms in the molecular chain of the organic moiety may range from about 2 to about 12; alternatively, from about 3 to about 10. The length of the molecular chain allows the hydrolysable groups from one silicone oligomer to interact with the hydrolysable groups of another silicone oligomer, thereby, enhancing the cross-linking of the outer layer as further defined herein.

The organofunctional end groups may include, but not be limited to isocyanates, anhydrides, amides, imides, acrylates, chlorotriazines, epoxides, or organic acids, including monomers, polymers, and copolymers thereof. Several specific organofunctional end groups include, without limitation, amino, benzylamino, chloropropyl, epoxy, disulfide, epoxy/melamine, mercapto, tetrasulfido, ureido, vinyl, vinyl-benzyl-amino, and methacrylate groups. The organofunctional end groups are typically selected such that they exhibit reactivity towards the polymer that comprises the outer shell. For example, when the outer shell is a polyolefin, the organofunctional end group may comprise vinyl-benzyl-amino, vinyl, methacrylate, choropropyl, or benyzlamino functionality. Alternatively, the organofunctional end group comprises methacrylate functionality. Alternatively, the silicone oligomer is γ-methacryloxypropyl-trimethoxysilane. A specific example of a silicone oligomer is, without limitation, Silquest® A-174 silane (Momentive Performance Materials, Waterford, N.Y.).

The hydrolysable group of the silicone oligomer or silane coupling agent may comprise a halogen atom or methoxy, ethoxy, propoxy, or hydroxyl functionality, as well as mixtures thereof. One or more of the hyrolyzable groups may react with water to form hydroxyl or silanol groups through a hydrolysis process. Cross-linking of the surface of the outer shell in a voided latex particle may occur upon the condensation of one or more of the silanol groups of one silicone oligomer with one or more of the silanol or hydrolysable groups of other silicone oligomers that are adhered to the surface of the outer shell. The silicone oligomers as described herein may be added at any stage in the preparation of the voided latex particles provided that said oligomers at least partially or completely reside in or on the outer shell polymer of the particles after swelling.

The presence of the silicone oligomers on the outer surface 20 of or embedded within the outer shell 10 can be shown through scanning transmission electron microscopy (STEM) images in which elemental analysis for carbon (FIG. 2) or silicon (FIG. 3) is performed. In these images the concentration of the element that is being scanned for is shown or highlighted by increased illumination in the measured image.

Increased illumination of the outer shell 10 layer demonstrates the presence of a high concentration of both carbon and silicon as would be expected for the silicone oligomers.

When desired, the polymer of the outer shell 10 may be further characterized as comprising one or more different types of functional groups, particularly reactive, polar, chelating and/or heteroatom-containing functional groups. These functional groups may be varied and individually selected in order to modify certain characteristics of the voided latex particles 1, such as the wet adhesion, scrub resistance (washability), stain resistance, or solvent resistance, as well as the opacity or block resistance properties of a coating composition that incorporates one or more of the voided latex particles 1. The functional groups may be, without limitation, selected from 1,3-diketo, amino, ureido, or urea functional groups and/or combinations thereof. An example of 1,3-diketo functional groups, includes but is not limited to, acetoacetate functional groups, which may correspond to the general structure —OC(═O)CH₂C(═O)CH₃. Several examples of amino-functional groups include, without limitation, primary, secondary and tertiary amine groups. The amino functional group may be present in the form of a heterocyclic ring, such as an oxazoline ring, for one specific example among many. Other types of functional groups, such as hydroxyl (—OH), phosphate (e.g., PO₃H and salts thereof), fluorocarbon (e.g., perfluoroalkyl such as trifluoromethyl), polyether (e.g., polyoxyethylene, polyoxypropylene), and epoxy (e.g., glycidyl) groups may be used without exceeding the scope of the present disclosure. When desirable, the functional group may contain a Lewis base, such as the nitrogen atom of an amine. The functional group may be reactive, such that it is capable of reacting as an electrophile or as a nucleophile. The functional group, or a combination of functional groups in proximity to each other, may be capable of complexation or chelation. The functional groups may be selected to facilitate or enhance bonding with the silicone oligomer or silane coupling agent that is applied to the outer surface of the outer shell.

The functional groups may be introduced into the polymer of the outer shell by a variety of different processes. According to one aspect of the present disclosure, the functional groups may be introduced into the polymer of the outer shell during formation of the polymer, for example by polymerization of one or more polymerizable monomers that bear the desired functional groups (hereinafter “functionalized monomer”). Such polymerization may be carried out as a copolymerization wherein one or more functionalized monomers are copolymerized with one or more non-functionalized monomers. The monomers having functional groups described herein may be added at any stage in the preparation of the multi-stage emulsion provided that polymers bearing such functional groups at least partially or completely reside in the outer shell polymer of the particles after swelling.

For example, the outer shell polymer may be a copolymer of a vinyl aromatic monomer (e.g., styrene) and a free radical polymerizable ethylenically unsaturated monomer containing a functional group such as a- 1,3-diketo, amino, ureido, urea, hydroxyl, silane, fluorocarbon, aldehyde, ketone, phosphate or polyether functional group. The copolymer may contain one or more other additional types of co-monomers, such as alkyl (meth)acrylates (e.g., methyl methacrylate). The proportions of different monomers may be varied as may be desired to impart certain characteristics to the resulting outer shell polymer.

The free radical polymerizable ethylenically unsaturated monomer may contain a (meth)acrylate group or a (meth)acrylamide group. Such (meth)acrylate and (meth)acrylamide groups are capable of participating in free radical copolymerization with the vinyl aromatic monomer. Allylic groups may also be used to provide a polymerizable site of unsaturation.

Imidazolidinone (meth)acrylic monomers such as 2-(2-oxo-l-imidazolidinyl)ethyl (meth)acrylates and N-(2-(2-oxo-l-imidazolidinyl)ethyl (meth)acrylamides may be utilized as comonomers, for example. Other suitable free radical polymerizable ethylenically unsaturated monomers containing functional groups useful in the practice of the present invention include, without limitation, acetoacetoxy(meth)acrylates, allyl acetoacetate, derivitized methacrylamides such as methyloxalated diacetone (meth)acrylamides, aminoalkyl(meth)acrylates, and ethylenically unsaturated polymerizable aziridinyl monomers. Other suitable free radical polymerizable ethylenically unsaturated monomers containing useful functional groups include hydroethylethylene urea methacrylate (HEEUMA) and aminoethylethylene urea methacrylate (AEEUMA). The free radical polymerizable ethylenically unsaturated monomer may contain a plurality of functional groups on each monomer molecule; for example, the monomer may bear two or more urea and/or ureido groups per molecule. Illustrative examples of particular free radical polymerizable ethylenically unsaturated monomers suitable for use in the present invention as functionalized monomers include, but are not limited to, aminoethyl acrylate and methacrylate, dimethylaminopropyl-acrylate and methacrylate, 3-dimethylamino-2,2-dimethylpropyl-1-acrylate and methacrylate, 2-N-morpholinoethyl acrylate and methacrylate, 2-N-piperidinoethyl acrylate and methacrylate, N-(3-dimethylaminopropyl)acrylamide and methacrylamide, N-(3-dimethylamino-2,2-dimethylpropyl)acrylamide and methacrylamide, N-dimethylaminomethyl acrylamide and methacrylamide, N-(4-morpholino-methyl)acrylamide and methacrylamide, vinylimidazole, vinylpyrrolidone, N-(2-methacryloyloxyethyl)ethylene urea, N-(2-methacryloxyacetamidoethyl)-N, allylalkyl ethylene urea, N-methacrylamidomethyl urea, N-methacryloyl urea, 2-(1-imidazolyl)ethyl methacrylate, 2-(1-imidazolidin-2-on)ethylmethacrylate, N-(methacrylamido)ethyl urea, glycidyl (meth)acrylates, hydroxyalkyl(meth)acrylates such as 2-hydroxyethyl(meth)acrylates, gamma-(meth)acryloxypropyltrialkoxysilanes, N,N-dimethyl(meth)acrylamides, diacetone(meth)acrylamides, ethylene glycol (meth)acrylate phosphates, polyethylene glycol (meth)acrylates, polyethylene glycol methyl ether (meth)acrylates, diethylene glycol (meth)acrylates and combinations thereof.

According to another aspect of the present disclosure, a precursor polymer may first be prepared and then reacted so as to introduce the desired functional groups and thus provide the outer shell polymer. For example, amine functional groups may be introduced into the outer shell polymer by reacting a precursor polymer having carboxylic acid groups with an aziridine. In this specific example, the precursor polymer may be a polymer prepared by polymerizing an ethylenically unsaturated carboxylic acid, such as (meth)acrylic acid, optionally together with other monomers, such as alkyl (meth)acrylates and/or vinyl aromatic monomers (e.g., styrene).

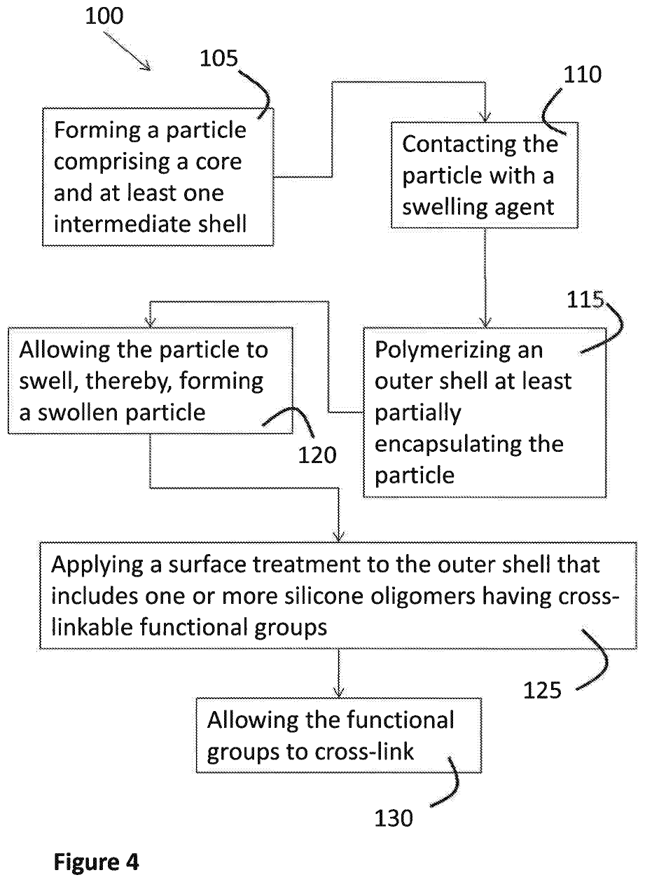

Referring now to FIG. 4, the process of preparing the voided latex particles of the present disclosure generally includes a multi-stage emulsion polymerization process 100. This process 100 comprises, consists of, or consists essentially of the formation 105 of a particle having a polymeric core derived from at least one hydrophilic monoethylenically unsaturated monomer and one or more intermediate shells. The particles are contacted 110 with a swelling agent, such as a base, which is capable of swelling the core, particularly in the presence of water. An outer shell is polymerized 115 around the particles so that the outer shell at least partially encapsulates the particles. The particles are allowed 120 to swell, thereby forming swollen particles. A surface treatment is applied 125 to the outer shell that includes one or more silicone monomers, oligomers, and/or polymers having polymerizable or cross-linkable functional groups. The functional groups are allowed 130 to cross-link in order to provide the voided latex particles with a cross-linked outer surface. For the purpose of this disclosure, a surface treatment” may be defined as the incorporation of a silane with polymerizable and or cross-coupling functionalities throughout core and/or shell sythesis and post polymerization of said silane after hollow particle synthesis. The surface treatment may undergo, without limitation, redox polymerization or thermal persulfate polymerization.

Unlike conventional processes, the process of the present disclosure combines swelling with the polymerization of the outer shell, which is accomplished by adding the swelling agent in the presence of less than 0.5% monomer based on the weight of the multi-stage emulsion polymer particles, and providing that substantially all of the swelling occurs during polymerization of the outer shell. As the term “substantially all of the swelling occurs during polymerization of the outer shell” is used, it is meant that the majority of swelling occurs during polymerization of the outer shell and that little or no swelling occurs during the addition of swelling agent in the presence of less than 0.5% monomer based on the weight of the multi-stage emulsion polymer particles. The occurrence of less than 10% or less than 5% of swelling during the addition of swelling agent, along with the remainder occurring during polymerization of the outer shell is within the scope of the present disclosure.

The percentage of swelling occurring during formation of the outer shell as compared to the addition of swelling agent is determined by comparing average size of the hollow cores as observed in STEM images obtained for the voided latex particles after addition of swelling agent as compared to the size of the hollow cores of voided latex particles measured after addition of the outer layer. When desirable, the swelling agent can be added prior to formation of an intermediate layer and swelling can be conducted during formation of the intermediate layer and an outer layer may be added after swelling. Further details relative to the process of preparing the voided latex particles of the present disclosure are found in International Patent Publication No. WO2016028511A1, the entire disclosure of which is incorporated herein by reference.

A monomer level of less than 0.5% monomer during addition of the swelling agent may be achieved by adding a sufficient amount of polymerization initiator prior to contacting with swelling agent to reduce the amount of monomer present during the contacting with swelling agent to less than 0.5% monomer based on the weight of the multi-stage emulsion polymer particles. Other methods of inducing polymerization may also be used.

The swollen core causes the intermediate and outer shells to expand, such that when the polymer particles are subsequently dried and/or re-acidified the shells remains enlarged in volume and a void is created within the particle as a result of the shrinkage of the swollen core. The voided latex particles may each contain a single void. However, in other aspects of the present disclosure, the individual voided latex particles may contain a plurality of voids (e.g., a voided latex particle may contain two or more voids within the particle). The voids may be connected to each other through pores or other passageways. The voids may be substantially spherical in shape, but may adopt other forms such as void channels, interpenetrating networks of void and polymer, or sponge-like structures.

The polymerization process of the present disclosure may be performed by using a batch process where the product of one stage is used in the stage that follows. For instance, the product of the core stage may be used to prepare the product of the next stage, be it an outer shell or an intermediate encapsulating polymer stage.

The free radical initiators suitable for the polymerization of the monomers used to prepare the voided latex particles may be any water soluble initiator suitable for aqueous emulsion polymerization. Examples of free radical initiators suitable for the preparation of the multi-stage emulsion polymer particles of the present application include hydrogen peroxide, tert-butyl peroxide, alkali metal persulfates such as sodium, potassium and lithium persulfate, ammonium persulfate, and mixtures of such initiators with a reducing agent. The amount of initiator may be, for example, from 0.01 to 3 percent by weight, based on the total amount of monomer.

When desirable, a redox polymerization initiator system may be used. In a redox free radical initiation system, a reducing agent may be used in conjunction with an oxidant. Reducing agents suitable for the aqueous emulsion polymerization include sulfites, such as alkali metal metabisulfite, hydrosulfite, or hyposulfite. In some embodiments, sugars might also be a suitable reducing agent for the aqueous emulsion polymerization. The amount of reducing agent may range from 0.01 to about 3 percent by weight based on the total amount of monomer.

The oxidant may include, for example, hydrogen peroxide and ammonium or alkali metal persulfates, perborates, peracetates, peroxides, and percarbonates and a water-insoluble oxidizing agent such as, benzoyl peroxide, lauryl peroxide, t-butyl peroxide, t-butyl hydroperoxide, 2,2′-azobisisobutyronitrile, t-amyl hydroperoxide, t-butyl peroxyneodecanoate, and t-butyl peroxypivalate. The amount of oxidant or oxidizing agent may range from 0.01 to about 3 percent by weight, based on the total amount of monomer.

The free radical polymerization temperature typically is in the range of about 10° C. to 100° C.; alternatively, between about 30° C. and 100° C.; alternatively, in the range of about 60° C. to about 100° C.; alternatively, in the range of about 30° C. to about 60° C.; alternatively, from about 30° C. to about 45° C. The type and amount of initiator may be the same or different in the various stages of the multi-stage polymerization.

One or more nonionic or ionic (e.g., cationic, anionic) emulsifiers, or surfactants, may be used, either alone or together, during polymerization in order to emulsify the monomers and/or to keep the resulting polymer particles in dispersed or emulsified form. The surfactant may be, without limitation, sodium dodecylbenzene.

The emulsifier or surfactant is generally used at a level of from zero to 3 percent based on the weight of the monomers. They can be added prior to the addition of any monomer charge, during the addition of a monomer charge or a combination thereof. When desirable, the core, the at least one intermediate shell, and/or the outer shell includes sodium dodecylbenzene sulfonate and optionally other surfactant(s).

The swelling agents are generally bases, including without limitation volatile bases, such as ammonia, ammonium hydroxide, and volatile lower aliphatic amines, such as morpholine, trimethylamine, triethylamine, carbonates, hydrogen carbonates, and the like. Other nonvolatile bases such as sodium hydroxide, potassium hydroxide, lithium hydroxide, zinc ammonium complex, copper ammonium complex, silver ammonium complex, strontium hydroxide, barium hydroxide and the like may also be used without exceeding the scope of the present disclosure. Solvents, such as, for example, ethanol, hexanol, octanol, and ester alcohols (e.g., Texanol® solvent, Eastman Chemical, Kingsport, Tenn.) may be added in order to enhance the penetration of the fixed or permanent base. Alternatively, the swelling agent is ammonia or ammonium hydroxide. The swelling agent may be in the form of an aqueous liquid or a gaseous medium containing a volatile base. The compositions of the outer shell and any intermediate encapsulating layers may be selected so as to be permeable to the swelling agent at ambient temperature or at a moderately elevated temperature. In one embodiment, the swelling agent is contacted with the voided latex particles at a temperature somewhat less than the glass transition temperature of the outer shell polymer. For example, the contacting temperature may be about 5° C. to about 20° C.; alternatively, about 10° C. to about 30 ° C.; alternatively, about 5° C. to about 40° C. less than the glass transition temperature of the outer shell polymer.

The weight ratio of the core to the outer shell may generally, for example, be in the range of from 1:5 to 1:20; alternatively, from 1:8 to 1:15. To decrease the dry density of the final voided latex particles, the amount of outer shell relative to the amount of core should generally be decreased; however, sufficient outer shell should be present such that the core is still at least partially encapsulated.

Conventional methods known to one skilled in the art for producing voided latex particles may be adapted for use in the present disclosure, provided these processes are modified to include the addition of swelling agent in the presence of less than 0.5% monomer based on the weight of the multi-stage emulsion polymer particles, and the cross-linking of the outer surface of the outer shell.

The voided latex particles of the present disclosure are useful in coating compositions, such as aqueous-based paint and paper coatings. Voided latex particles in accordance with this invention may be dispersed in an aqueous medium to form a latex emulsion capable of providing a desired level of opacity both in the wet and dry states. In addition to opacity, the use of the latex emulsion in or as a product composition may also optionally enhance other final product related properties, such as gloss, or brightness, wet adhesion, scrub resistance, solvent resistance, stain resistance, or the like.

The latex emulsions may comprise up to about 50 wt. %, alternatively, up to about 45 wt. % of the voided latex particles based on the total weight of the latex emulsion. The lower limit for incorporation of the voided latex particles into the latex emulsion may be set at about 1 wt. %; alternatively, 5 wt. %; alternatively, about 15 wt. %; alternatively, about 25 wt. %; alternatively, about 30 wt. % based on the total weight of the latex emulsion.

The latex emulsion may be used, with or without the incorporation of other additives, as a coating, paint, adhesive, sealant, caulk, or ink used in an application requiring a predetermined degree of opacity. The coating, paint, adhesive, sealant, caulk, or ink may be used, without limitation, in a traffic paint application, in a decorative or architectural application, as a pressure-sensitive adhesive, in a deck application, in a roof application, in a “dry-fall” application, in label applications, or in a primer application.

The latex compositions may further comprise, consist of, or consist essentially of one or more additional polymers, as well as any other known or desired additives. The additional polymers may include, but not be limited to, a polymer or copolymer that is derived from one or more of (meth)acrylate, vinyl aromatic, ethylenically unsaturated aliphatic, or vinyl ester monomers, as well as various combinations thereof. The other additives, may comprise without limitation, any type of pigments or colorants, fillers, dispersants or surfactants, coalescent agents, pH neutralizing agents, plasticizers, defoamers, surfactants, thickeners, biocides, co-solvents, rheology modifiers, wetting or spreading agents, leveling agents, conductive additives, adhesion promoters, anti-blocking agents, anti-cratering agents or anti-crawling agents, anti-freezing agents, corrosion inhibitors, anti-static agents, flame retardants, optical brighteners, UV absorbers or other light stabilizers, chelating agents, crosslinking agents, flattening agents, flocculants, humectants, insecticides, lubricants, odorants, oils, waxes or anti-slip aids, soil repellants, or stain resistant agents, as well as mixtures and combinations thereof. The selection of additives incorporated into a coating composition is determined based on a variety of factors, including the nature of the acrylic polymer or latex dispersion and the intended use of the coating composition, to name a few.

Several examples of pigments and colorants include, without limitation, metal oxides, such as titanium dioxide, zinc oxide, or iron oxide, as well as organic dyes, or combinations thereof. Examples of fillers may include, but not be limited to, calcium carbonate, nepheline syenite, feldspar, diatomaceous earth, talc, aluminosilicates, silica, alumina, clay, kaolin, mica, pyrophyllite, perlite, baryte, or Wollastonite, and combinations thereof.

Several examples of co-solvents and plasticizers include ethylene glycol, propylene glycol, diethylene glycol, and combinations thereof, among others. Typical coalescents, which aid in film formation during drying, include but are not limited to, ethylene glycol monomethyl ether, ethylene glycol monobutyl ether, ethylene glycol monoethyl ether acetate, ethylene glycol monobutyl ether acetate, diethylene glycol monobutyl ether, and diethylene glycol monoethyl ether acetate, as well as combinations thereof.

Several examples of dispersants may include, without limitation, any known nonionic surfactants, such as ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates and/or ionic surfactants, such as alkylphenoxy polyethoxyethanols or ethylene oxide derivatives of long chain carboxylic acids, as well as polyacid dispersants, such as polyacrylic acid or polymethylacrylic acid or salts thereof, and hydrophobic co-polymeric dispersants, such as co-polymers of acrylic acid, methacrylic acid, or maleic acid with hydrophobic monomers.

Several examples of the thickening agents may include, without limitation, hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof.

The incorporation of various defoamers, such as, for example, polydimethylsiloxanes (PDMS) or polyether-modified polysiloxanes, may be done to minimize frothing during mixing and/or application of the coating composition. Suitable biocides can be incorporated to inhibit the growth of bacteria and other microbes in the coating composition during storage.

Coatings, which may include, without limitation, paints, adhesives, sealants, caulks, and inks, formed from the latex emulsions described herein, as well as methods of forming these coatings are believed to be within the scope of the present disclosure. Generally, coatings are formed by applying a coating formulation described herein to a surface, and allowing the coating to dry to form the coating or film. The resulting dried coatings typically comprise, at minimum, a plurality of layered polymer particles. The coating formulations and/or the dried coatings can further comprise one or more additional polymers and/or additives as described above or known to one skilled in the art. The coating thickness can vary depending upon the application of the coating. The thickness of the coating may be any thickness desirable for use in a particular application; alternatively, the range for the dry thickness of the coating is between about 0.025 mm (1 mil) to about 2.5 mm (100 mils).

The latex emulsions and the coatings formed therefrom can be applied to a variety of different surfaces including, but not limited to metal, asphalt, concrete, stone, ceramic, wood, plastic, polymer, polyurethane foam, glass, and combinations thereof. The coatings can be applied to the interior or exterior surfaces of a commercial product or manufactured good or item. When desirable, the surface may be an architectural surface, such as a roof, a wall, a floor, or a combination thereof. The latex compositions may be applied using any available method, including, without limitation, rolling, brushing, flow coating, dip coating, or spray coating, including but not limited to air spray, air-assisted spray, airless spray, high volume-low pressure (HVLP) spray, and air-assisted airless spray.

Other aspects of the present disclosure include:
1. Hollow or voided latex particles comprising:

a core comprising a hydrophilic component; at least one intermediate layer comprising, as polymerized units, one or more hydrophilic monoetheylenically unsaturated monomer, one or more nonionic monoethylenically unsaturated monomer, or mixtures thereof;

an outer shell comprising a polymer having a T_{g} of at least 60° C.; and

a surface treatment applied to the outer shell comprising a plurality of silicone monomers, oligomers, and/or polymers having polymerizable or cross-linkable functional groups, the functional groups being cross-linked with one another in order to provide a cross-linked outer surface;

wherein the core and the at least one intermediate layer are contacted with a swelling agent in the presence of less than 0.5% monomer based on the overall weight of the voided latex particles,

wherein one or more of the core, the intermediate layer, or the outer shell includes sodium dodecylbenzene sulfonate, and optionally other surfactants.
2. The hollow or voided particles according to claim 1, wherein the particles further comprise a polymerization initiator selected as one from a free radical initiator and a redox polymerization initiator.
3. The hollow or voided particles according to any of claim 1 or 2, wherein the at least one intermediate layer comprises a cross-linked polymer.
4. The hollow or voided particles according to any of claims 1-3, wherein the swelling agent is sodium hydroxide or ammonia hydroxide.
5. The hollow or voided particles according to any of claims 1-4, wherein the core comprises a polymer seed comprising methyl methacrylate and a seed coating of copolymerized methacrylic acid and methyl methacrylate.
6. The hollow or voided particles according to any of claims 1-5, comprising a first intermediate layer that comprises a copolymer of methacrylic acid, styrene, and methyl methacrylate; and a second intermediate layer comprising copolymerized methyl methacrylate and styrene.
7. The hollow or voided particles according to any of claims 1-6, wherein the outer shell is polymerized styrene or styrene copolymerized with one or more functionalized monomers.
8. The hollow or voided particles according to any of claim 1-7, wherein the surface treatment comprises γ-methacryloxypropyltrimethoxysilane or trimethyl-methyl silyl methacrylate.
9. The hollow or voided particles according to any of claims 1-8, wherein the surface treatment is undergoes redox polymerization or thermal persulfate polymerization.
10. A latex emulsion comprising:

5 wt. % to about 60 wt. % hollow or voided latex particles based on the overall weight of the latex emulsion;

about 40 wt. % to 95 wt. % of an aqueous medium in which the voided latex particles are dispersed; and

optionally, one or more other polymers, pigments, or additives;

wherein the voided latex particles comprise:
a core comprising a hydrophilic component;
at least one intermediate layer comprising, as polymerized units, one or more hydrophilic monoetheylenically unsaturated monomer, one or more nonionic monoethylenically unsaturated monomer, or mixtures thereof;
an outer shell comprising a polymer having a T_{g} of at least 60° C.; and
a surface treatment applied to the outer shell comprising a plurality of silicone monomers, oligomers, and/or polymers having polymerizable or cross-linkable functional groups, the functional groups being cross-linked with one another in order to provide a cross-linked outer surface;
wherein the core and the at least one intermediate layer are contacted with a swelling agent in the presence of less than 0.5% monomer based on the overall weight of the voided latex particles,
wherein one or more of the core, the intermediate layer, or the outer shell includes sodium dodecylbenzene sulfonate, and optionally other surfactants.
11. The latex emulsion according to claim 10, wherein the at least one intermediate layer comprises a cross linked polymer and the outer shell is polymerized styrene or styrene copolymerized with one or more functionalized monomers.
12. The latex emulsion according to any of claim 10 or 11, wherein the swelling agent is sodium hydroxide or ammonia hydroxide.
13. The latex emulsion according to any of claims 10-12, wherein the core comprises a polymer seed comprising methyl methacrylate and a seed coating of copolymerized methacrylic acid and methyl methacrylate;

a first intermediate layer that comprises a copolymer of methacrylic acid, styrene, and methyl methacrylate; and

a second intermediate layer comprising copolymerized methyl methacrylate and styrene.
14. The latex emulsion according to any of claims 10-13, wherein the surface treatment comprises γ-methacryloxypropyltrimethoxysilane or trimethyl-methyl silyl methacrylate.
15. A process for forming hollow or voided latex particles in an emulsion, wherein the process comprises:

forming a particle comprising a core and at least one intermediate layer;

contacting the particle with a swelling agent;

polymerizing an outer shell at least partially encapsulating the particle;

allowing the particle to swell, thereby, forming a swollen particle;

applying a surface treatment to the outer shell having cross-linkable functional groups; and

allowing the functional groups to crosslink;

wherein:the core comprises a hydrophilic component;

the at least one intermediate layer comprises, as polymerized units, one or more hydrophilic monoetheylenically unsaturated monomer, one or more nonionic monoethylenicaally unsaturated monomer, or mixtures thereof;

the outer shell comprises a polymer having a Tg of at least 60° C.;

the surface treatment applied to the outer shell comprises a plurality of silicone monmers, oligomers, and/or polymers having polymerizable or cross-linkable functional groups, the functional groups being cross-linked with one another in order to provide a cross-linked outer surface;

the core and the at least one intermediate layer are contacted with swelling agent in the presence of less than 0.5% monomer based on the weight of the multi-stage emulsion polymer particles,

wherein one or more of the core, the intermediate layer, or the outer shell includes sodium dodecylbenzene sulfonate, and optionally other surfactants and substantially all of the swelling occurs during polymerization of the outer shell.
16. The process according to claim 15, further comprising adding a sufficient amount of a polymerization initiator prior to said contacting with swelling agent to reduce the amount of monomer present during the contacting with swelling agent to less than 0.5% monomer based on the weight of the voided latex particles.
17. The process according to any of claim 15 or 16, wherein the at least one intermediate layer comprises a cross linked polymer, the swelling agent is sodium hydroxide, the core comprises a polymer seed comprising methyl methacrylate and a seed coating of copolymerized methacrylic acid and methyl methacrylate, the outer shell is polymerized styrene or styrene copolymerized with one or more functionalized monomers, and the surface treatment comprises γ-methacryloxypropyltrimethoxysilane or trimethyl-methyl silyl methacrylate.

The following specific examples are given to illustrate the composition of the voided latex particles, as well as the latex emulsions and coatings formed therefrom and methods of preparing the same, and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

### EXAMPLE 1

### Preparation of Voided Latex Particles with 15% Functionalization

This example demonstrates the formation of voided latex particles by an emulsion polymerization process. A 1^{st} monomer pre-emulsion mixture for forming the core is prepared by mixing a prescribed amount of methyl methacrylate with methacrylic acid in a reactor at a temperature between 85-93° C. Then a 2^{nd} monomer pre-emulsion mixture having a different ratio of methyl methacylate and methacryllic acid monomers is prepared and subsequently used to form the 1^{st} intermediate layer. The 2^{nd} pre-emulsion mixture is added to the reactor containing the swellable core particles while maintaining the temperature between about 75° C. to about 85° C.

A 3^{rd} pre-emulsion mixture comprising styrene, oleic acid, and ethylene glycol dimethacrylate (EGDMA) is prepared and added to the reactor at a temperature between about 75° C. to about 85° C. to form a 2^{nd} intermediate layer on the latex particles. The reaction temperature is increased to be in the range of about 90° C. to 95° C. for a predetermined amount of time prior to forming the outer shell.

A 4^{th} pre-emulsion mixture comprising styrene and γ-methacryloxypropyl-trimethoxysilane is prepared such that the silicone oligomer is present in the outer shell on the order of about 15.5 wt. % based on the overall weight of the outer shell. The 4^{th} pre-emulsion mixture is added to the reactor at a temperature between about 80° C. to about 95° C.

Ammonia hydroxide is then added as a swelling agent and the core is allowed to swell. The hollow or voided latex particles so formed are then collected and stored for characterization and further utilization. One or more of the core, intermediate layers, and outer shell includes a predetermined amount of sodium dodecylbenzene sulfonate as a surfactant.

### EXAMPLE 2

### Preparation of Voided Latex Particles with 60% Functionalization

This example demonstrates the formation of voided latex particles by an emulsion polymerization process. A 1^{st} monomer pre-emulsion mixture for forming the core is prepared by mixing a prescribed amount of methyl methacrylate with methacrylic acid in a reactor at a temperature between 85-93° C. Then a 2^{nd} monomer pre-emulsion mixture having a different ratio of methyl methacylate and methacryllic acid monomers is prepared and subsequently used to form the 1^{st} intermediate layer. The 2^{nd} pre-emulsion mixture is added to the reactor containing the swellable core particles while maintaining the temperature between about 75° C. to about 85° C.

A 3^{rd} pre-emulsion mixture comprising styrene, oleic acid, and ethylene glycol dimethacrylate (EGDMA) is prepared and added to the reactor at a temperature between about 75° C. to about 85° C. to form a 2^{nd} intermediate layer on the latex particles. The reaction temperature is increased to be in the range of about 90° C. to 95° C. for a predetermined amount of time prior to forming the outer shell.

A 4^{th} pre-emulsion mixture comprising styrene and γ-methacryloxypropyl-trimethoxysilane is prepared such that the silicone oligomer is present in the outer shell on the order of about 60 wt. % based on the overall weight of the outer shell. The 4^{th} pre-emulsion mixture is added to the reactor at a temperature between about 80° C. to about 95° C.

Ammonia is then added as a swelling agent and the core is allowed to swell. The hollow or voided latex particles so formed are then collected and stored for characterization and further utilization. One or more of the core, intermediate layers, and outer shell includes a predetermined amount of sodium dodecylbenzene sulfonate as a surfactant.

Within this specification, embodiments have been described in a way which enables a clear and concise specification to be written, but it in intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. Hollow or voided latex particles comprising:
a core comprising a hydrophilic component;
at least one intermediate layer comprising, as polymerized units, one or more hydrophilic monoetheylenically unsaturated monomer, one or more nonionic monoethylenically unsaturated monomer, or mixtures thereof;
an outer shell comprising a polymer having a T_{g} of at least 60° C.; and
a surface treatment applied to the outer shell comprising a plurality of silicone monomers, oligomers and/or polymers having polymerizable or cross-linkable functional groups, the functional groups being cross-linked with one another in order to provide a cross-linked outer surface;
wherein the core and the at least one intermediate layer are contacted with a swelling agent in the presence of less than 0.5% monomer based on the overall weight of the voided latex particles,
wherein one or more of the core, the intermediate layer, or the outer shell includes sodium dodecylbenzene sulfonate, and optionally other surfactants.

2. The hollow or voided particles of claim 1, wherein the particles further comprise a polymerization initiator selected as one from a free radical initiator and a redox polymerization initiator.

3. The hollow or voided particles of claim 1, wherein the at least one intermediate layer comprises a cross-linked polymer.

4. The hollow or voided particles of claim 1, wherein the swelling agent is sodium hydroxide or ammonia hydroxide.

5. The hollow or voided particles of claim 1, wherein the core comprises a polymer seed comprising methyl methacrylate and a seed coating of copolymerized methacrylic acid and methyl methacrylate.

6. The hollow or voided particles of claim 1, comprising a first intermediate layer that comprises a copolymer of methacrylic acid, styrene, and methyl methacrylate.

7. The hollow or voided particles of claim 6, further comprising a second intermediate layer comprising copolymerized methyl methacrylate and styrene.

8. The hollow or voided particles of claim 1, wherein the outer shell is polymerized styrene or styrene copolymerized with one or more functionalized monomers.

9. The hollow or voided particles of claim 1, wherein the surface treatment comprises γ-methacryloxypropyltrimethoxysilane or trimethyl-methyl silyl methacrylate.

10. The hollow or voided particles of claim 1, wherein the surface treatment is undergoes redox polymerization or thermal persulfate polymerization.

11. A latex emulsion comprising:
5 wt. % to about 60 wt. % hollow or voided latex particles based on the overall weight of the latex emulsion;
about 40 wt. % to 95 wt. % of an aqueous medium in which the voided latex particles are dispersed; and
optionally, one or more other polymers, pigments, or additives;
wherein the voided latex particles comprise:
a core comprising a hydrophilic component;
at least one intermediate layer comprising, as polymerized units, one or more hydrophilic monoetheylenically unsaturated monomer, one or more nonionic monoethylenically unsaturated monomer, or mixtures thereof;
an outer shell comprising a polymer having a T_{g} of at least 60° C.; and
a surface treatment applied to the outer shell comprising a plurality of silicone oligomers having cross-linkable functional groups, the functional groups being cross-linked with one another in order to provide a cross-linked outer surface;
wherein the core and the at least one intermediate layer are contacted with a swelling agent in the presence of less than 0.5% monomer based on the overall weight of the voided latex particles,
wherein one or more of the core, the intermediate layer, or the outer shell includes sodium dodecylbenzene sulfonate, and optionally other surfactants.

12. The latex emulsion of claim 11, wherein the voided particles further comprise a polymerization initiator selected as one from a free radical initiator and a redox polymerization initiator.

13. The latex emulsion of claim 11, wherein the at least one intermediate layer comprises a cross linked polymer.

14. The latex emulsion of claim 11, wherein the swelling agent is sodium hydroxide or ammonia hydroxide.

15. The latex emulsion of claim 11, wherein the core comprises a polymer seed comprising methyl methacrylate and a seed coating of copolymerized methacrylic acid and methyl methacrylate.

16. The latex emulsion of claim 11, comprising a first intermediate layer that comprises a copolymer of methacrylic acid, styrene, and methyl methacrylate; and a second intermediate layer comprising copolymerized methyl methacrylate and styrene.

17. The latex emulsion of claim 11, wherein the outer shell is polymerized styrene or styrene copolymerized with one or more functionalized monomers.

18. The latex emulsion of claim 11, wherein the surface treatment comprises γ-methacryloxypropyltrimethoxysilane or trimethyl-methyl silyl methacrylate.

19. The latex emulsion of claim 11, wherein the surface treatment undergoes redox polymerization or thermal persulfate polymerization.

20. A process for forming hollow or voided latex particles in an emulsion, wherein the process comprises:
forming a particle comprising a core and at least one intermediate layer;
contacting the particle with a swelling agent;
polymerizing an outer shell at least partially encapsulating the particle;
allowing the particle to swell, thereby, forming a swollen particle;
applying a surface treatment to the outer shell having cross-linkable functional groups; and
allowing the functional groups to crosslink;
wherein:the core comprises a hydrophilic component;
the at least one intermediate layer comprises, as polymerized units, one or more hydrophilic monoetheylenically unsaturated monomer, one or more nonionic monoethylenicaally unsaturated monomer, or mixtures thereof;
the outer shell comprises a polymer having a Tg of at least 60° C.;
the surface treatment applied to the outer shell comprises a plurality of silicone monomers, oligomers, and/or polymers having polymerizable or cross-linkable functional groups, the functional groups being cross-linked with one another in order to provide a cross-linked outer surface;
the core and the at least one intermediate layer are contacted with swelling agent in the presence of less than 0.5% monomer based on the weight of the multi-stage emulsion polymer particles,
wherein one or more of the core, the intermediate layer, or the outer shell includes sodium dodecylbenzene sulfonate, and optionally other surfactants and substantially all of the swelling occurs during polymerization of the outer shell.

21. The process of claim 20, further comprising adding a sufficient amount of a polymerization initiator prior to said contacting with swelling agent to reduce the amount of monomer present during the contacting with swelling agent to less than 0.5% monomer based on the weight of the voided latex particles.

22. The process of claim 20, wherein the at least one intermediate layer comprises a cross linked polymer, the swelling agent is sodium hydroxide, the core comprises a polymer seed comprising methyl methacrylate and a seed coating of copolymerized methacrylic acid and methyl methacrylate, the outer shell is polymerized styrene or styrene copolymerized with one or more functionalized monomers, and the surface treatment comprises γ-methacryloxypropyltrimethoxysilane or trimethyl-methyl silyl methacrylate.

23. The process of claim 20, wherein the surface treatment undergoes redox polymerization or thermal persulfate polymerization.
